(19) United States
(12) Patent Application Publication
(10) Pub. No.: US 2014/0056707 A1
(43) Pub. Date: Feb. 27, 2014

(54) CONVEYANCE DEVICE FOR AN ENERGY COLLECTOR

(71) Applicant: Windular Research and Technologies Inc., Chelmsford (CA)

(72) Inventor: Kerry Patrick Donnelly, Mooresville, NC (US)

(73) Assignee: Windular Research and Technologies Inc., Chelmsford (CA)

(21) Appl. No.: 13/973,582

(22) Filed: Aug. 22, 2013

Related U.S. Application Data
(60) Provisional application No. 61/692,035, filed on Aug. 22, 2012.

(51) Int. Cl. F03D 7/02

(52) U.S. Cl. CPC F03D 7/0204
USPC 416/9; 307/145

(57) ABSTRACT

The present invention provides a conveyance device for an energy collector such as a wind turbine, solar collector, or a combination thereof. The conveyance device is configured to orient the energy collector by moving the device to compensate for a change in the source of energy such as a change in power, direction, speed, location and a combination thereof. The conveyance device includes a track configured to be positioned near a support structure such as a telecommunications tower and first and second electrical contacts configured to electrically connect the energy collector to an electrical load. The conveyance device is also configured to receive an energy collector configured to be attached to the track such that the energy collector is movable relative to the track. In this manner, there is provided a device for adjusting the orientation of the wind turbine or solar collector such that it collects energy efficiently.

### PRIORITY

This is a non-provisional United States patent application that claims priority from provisional U.S. Patent Application No. 61/692,035 filed on Aug. 22, 2012 and which is incorporated herein in its entirety.

### FIELD OF THE INVENTION

The invention relates generally to an apparatus for orientably mounting an electrical generation device and, more specifically, to a system for mounting devices such as wind turbines and solar collectors on nonstandard structures including new structures and existing structures, such as towers, communication structures, telecom towers and the like such that the devices are configured to be laterally movable.

### BACKGROUND OF THE INVENTION

The present invention is in the technical field of producing electricity from renewable resources including wind power and solar power. More particularly, the present invention is related to the generation of electrical power by devices mounted on telecom towers, communication structures and other non-standard vertical structures. A problem common to such structures is that the characteristics of construction generally require a fixed placement installation of an energy collection device or energy collector. Fixed placement makes it impossible to align the device in accordance with changes in the renewable resource such as a change in direction from which the resource is originating and the power of the resource. Another problem common to such structures is that the apex of the tower is generally not available for pivotally mounting a collection device such as a wind turbine due to the presence of such obstacles to axial rotation as antennas. As a result, it is not possible to align wind turbines or solar panels in the conventional fashion.

Renewable energy resources such as wind power and solar power are readily available in many areas and are currently utilized as energy sources for various applications. Known devices for collecting energy from naturally occurring sources include wind turbines and solar panels. Conventionally, such devices are oriented to take best advantage of the source of renewable energy. Some of the factors that can be considered when determining proper orientation of the energy collector include but are not limited to: the power, speed, direction, and location of the natural source. However, fixed installations of such devices cannot be operated at maximum efficiency due to natural variation of these factors.

One conventional structure for mounting a wind turbine is referred to as a Horizontal Axis Wind Turbines (“HAWT”). Conventional HAWT for the generation of electricity are typically mounted at the top portion of a tower structure in a coaxial orientation relative to the tower structure. This allows the turbine to rotate coaxially around the tower axis. The direction and manner of rotation dictated by the direction of air flow presented to the turbine. In this regard, the manner in which a horizontal axis wind turbine is oriented is passive.

One problem with a conventional HAWT is that installation on a supporting structure requires that a path around the apex of the structure be free and clear of appurtenances and interferences. The apex is often the part of the supporting structure that is heavily utilized for installation of telecom appurtenances.

Another problem with the conventional HAWT installation on a supporting structure is that mounting a wind turbine at a position on a tower other than at the tower apex requires the turbine to be in a fixed, non-rotational position. This can result in extreme inefficiencies in the operation of the turbine due to an inability to drive the turbine into oncoming airflow.

Another problem with the conventional HAWT installation on a supporting structure is that mounting a wind turbine at a position on a tower other than at the tower apex results in turbulence being created as the wind passes through and/or around the tower structure itself prior to hitting the turbine.

Another problem with conventional mounting of energy collecting devices is that if such a device is mounted adjacent to an existing structure such as a tower, the efficiency of the device can be affected due to obstructions and/or turbulence created by the tower.

Another problem with conventional devices for mounting a wind turbine at a position other than the apex of the tower is that it is difficult to steer the turbine into the apparent airflow.

Another problem with conventional mounting systems for wind turbine is that it is difficult to provide electrical connections to a wind turbine that is mounted other than at the apex of a supporting structure. These electrical connections include those associated with providing data links to hardware of the HAWT and electrical service for the take-off of produced electricity.

The present invention is configured to address these problems.

### SUMMARY OF THE INVENTION

The present invention provides an apparatus for positioning a collector of natural energy such as a wind turbine, solar panel, array of solar panels, or a hybrid wind/solar system such that the collector of natural energy can be affixed to a structure in a manner to optimize collection of the targeted energy. In this regard, the present invention provides a device for movement of an energy collector along a lateral path up to 360° around the structure in order to align the energy collector in a predetermined direction relative to the energy source. In this regard, the apparatus is configured to provide for positioning of a collector of natural energy such that the collector can be properly oriented when the collector is mounted at locations where axial rotations throughout 360° is not feasible or do not result in optimization of energy collection.

According to one embodiment of the present invention there is provided a yawing apparatus configured to orient a device for collecting energy from a natural source by moving the device relative to the natural source to compensate for a change in the natural source. The yawing apparatus includes a track configured to be positioned near a support structure; an energy collector configured to be attached to the track such that the energy collector is movable relative to the track; a first electrical contactor electrically connected to the energy collector; a second electrical contactor electrically connected to an electrical load. The first electrical contactor is movable relative to the second electrical contactor. The first and second electrical contactors are also configured such that the first electrical contactor can be electrically connected to the second electrical contactor such that electricity can flow from the energy collector through the first electrical contactor and through the second electrical contactor to the electrical load.

According to one aspect of the present invention, the track is configured to support the energy collector such that the energy collector is spaced-away from the support structure.

According to another aspect of the present invention, the first and second electrical contactors are configured such that the flow of electricity from the first electrical contactor to the second electrical contactor is not interrupted when the first electrical contactor moves relative to the second electrical contactor.

According to yet another aspect of the present invention, the energy collector is a wind turbine.

According to yet another aspect of the present invention, the support structure is a telecommunications tower.

According to yet another aspect of the present invention, the track includes a first rail and a second rail.

According to yet another aspect of the present invention, the second electrical contactor is stationary relative to the track.

According to yet another aspect of the present invention, the first electrical contactor includes electrically conductive connectors configured to electrically contact the second electrical contactor and the second electrical contactor defines a band around the support structure.

According to yet another aspect of the present invention, the first electric contactor electrically defines a band around the support structure and the second electrical contactor includes electrically conductive connectors configured to electrically contact the first electrical contactor.

According to yet another aspect of the present invention, the energy collector includes at least one solar panel.

According to another embodiment of the present invention, there is provided an apparatus for aligning an energy collector relative to a variable source of energy by moving the energy collector relative to a predetermined point. The apparatus includes a track configured to support an energy collector such that the energy collector is spaced-away from the predetermined point. A path P is defined by the track such that the energy collector can be moved along the path P between a first location and a second location. The track is configured such that the energy collector is oriented toward a first direction when the energy collector is at the first location and the track is configured such that the energy collector is oriented toward a second direction when the energy collector is at the second location.

According to yet another aspect of the present invention, the energy collector is configured such that it can be electrically disconnected from an electrical load when the energy collector is between the first location and the second location.

According to another embodiment of the present invention there is provided a method for aligning an energy collector relative to a variable source of energy by moving the energy collector relative to a predetermined point. The method comprising the steps of: A) providing an energy collector, a track configured to support the energy collector such that the energy collector is spaced-away from the predetermined point, a path P defined by the track such that the energy collector can be moved along the path P between a first location and a second location, and wherein the energy collector is configured to be oriented in a first direction when the energy collector is at the first location and the energy collector is configured to be oriented in a second direction when the energy collector is at the second location; B) positioning the energy collector at the first location on path P such that the energy collector is oriented in the first direction; C) moving the energy collector along path P between the first location on path P and the second location on path P; D) positioning the energy collector at the second location on path P such that the energy collector is oriented in the second direction; E) operating the energy collector such that electricity is generated; and F) providing the electricity that is generated to an electrical load.

According to another aspect of the present invention, the above method includes the further steps of G) positioning the energy collector such that it is electrically connected to the electrical load for at least some portion of a first time period during which the energy collector is at the first position; H) disconnecting the energy collector electrically from the electrical load such that the energy collector is not electrically connected to the electrical load for at least some portion of a second time period during which the energy collector is moving between the first position and the second position; and I) positioning the energy collector such that it is electrically connected to the electrical load such that they are electrically connected for at least some portion of a third time period during which the energy collector is at the second position.

### BRIEF DESCRIPTION OF THE DRAWINGS

For a fuller understanding of the nature and objects of the present invention, reference should be made to the following detailed description taken in connection with the accompanying drawings, wherein:

FIG. 1 is a perspective view of the present invention mounted on an existing communications tower formed of a monopole according to two embodiments;

FIG. 2 is a front view of an apparatus for orienting an energy collector such as a wind turbine according to one embodiment of the present invention in which a wind turbine and a tower supported by guy wires are shown;

FIG. 3 is a plan view of one embodiment of the present invention showing a circular conveyance device mounted coaxially on an existing tower and supporting a wind turbine;

FIG. 4 is a perspective view from below of a wind turbine mounted on a communications tower according to the embodiment of the present invention shown in FIG. 3;

FIG. 5 is a partially cutaway perspective view from below of a wind turbine and a carriage assembly mounted together on a rail system according to an embodiment of the present invention;

FIG. 6 is a partially cutaway perspective view from above of a wind turbine and a carriage assembly mounted together on a rail system according to an embodiment of the present invention;

FIG. 7 is a perspective view of electrical connectors according to an embodiment of the present invention;

FIG. 8 is a partial perspective view of contacting bands or bars mounted on the support rails such that they are stationary relative to the support rails according to an embodiment of the present invention shown in FIG. 7;

FIG. 9 is a detailed cut away view of an insulated support connector for connecting a contacting band or bar to a slip ring structure taken along line 9-9 in FIG. 8;

FIG. 10 is a perspective view of two wind turbines mounted on an existing structure according to yet another alternative embodiment of the present invention;

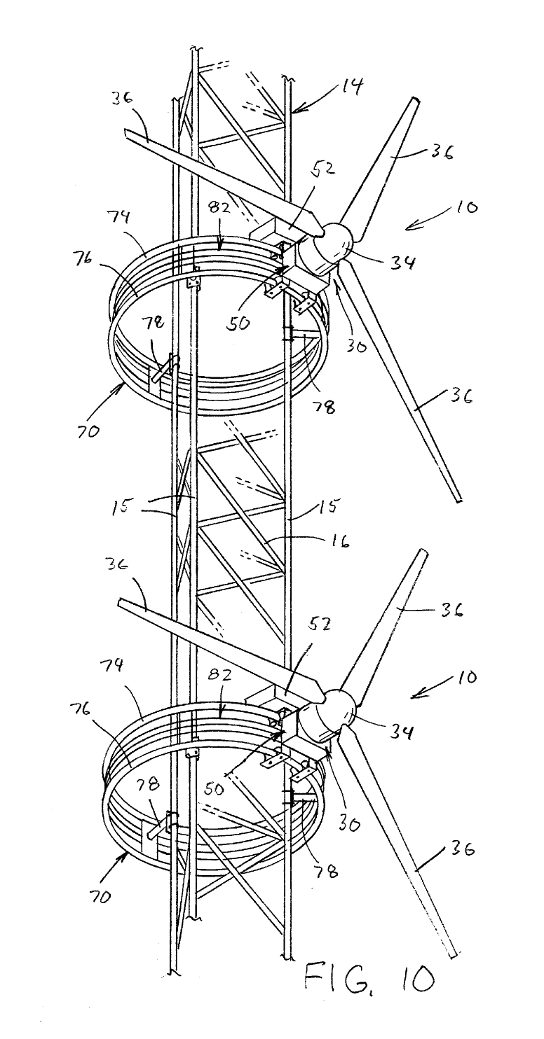

FIG. 11 is a perspective view of a conveyance device on an existing structure according to yet another alternative embodiment of the present invention;

FIG. 12 is a plan view of the embodiment of the conveyance device shown in FIG. 11;

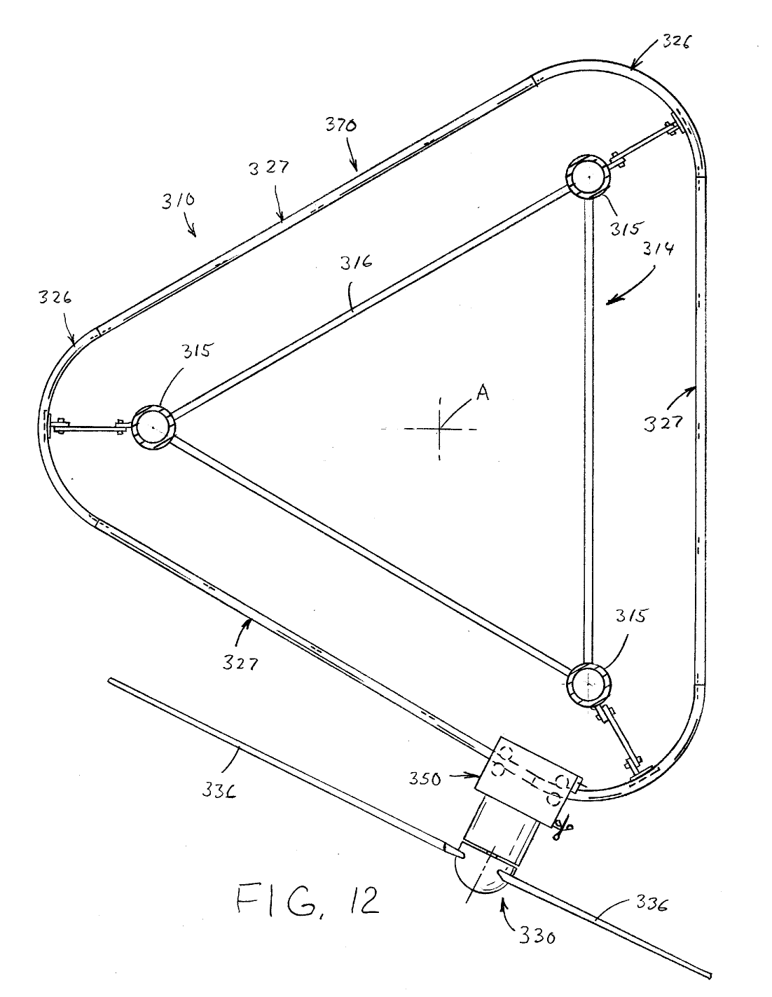

FIG. 13 is a perspective view of a wind turbine mounted on an existing structure according to yet another alternative embodiment of the present invention; and

FIG. 14 is a perspective view of a track according to one embodiment of the present invention showing a solar array positioned on a track configured to convey the solar array laterally such that the solar array can be oriented in different directions as a result of the lateral movement.

### DETAILED DESCRIPTION OF THE PREFERRED EMBODIMENTS

Embodiments of the present invention are directed to a device for conveying a wind turbine, solar panels, hybrid solar/wind collectors, or other energy collector such that the collector is aligned in a predetermined position relative to the source of energy. More specifically, the present invention provides a device for conveying the energy collector such that the collector is properly aligned when the collector is not mounted axially. By way of example and not limitation, such a location could be on a pre-existing or newly built structure such as a tower, silo, building, or the like or when the collector is mounted below the apex of such a structure.

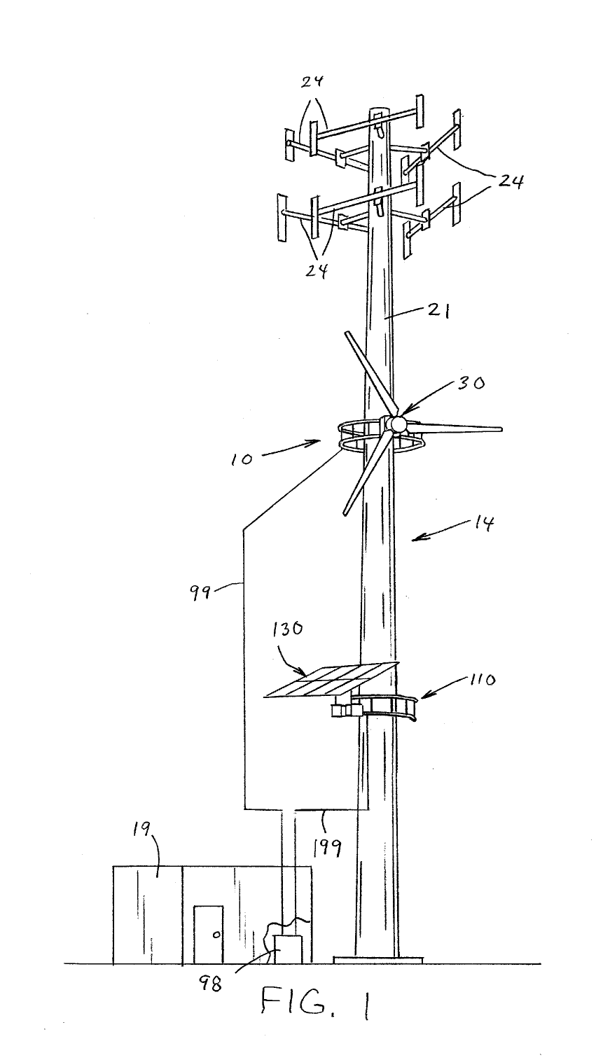

Referring to FIG. 1, in accordance with an embodiment of the invention, there is provided an energy collector conveyance device 10 that has a wind turbine 30 mounted thereon. FIG. 1 also shows an energy collector conveyance device 110 according to an alternative embodiment in which the energy collector is an array of solar panels 130. As shown in FIG. 1, according to one embodiment of the present invention, multiple devices 10 can be utilized to position more than one energy collector device on a single support structure such as a communications tower 14. Communication tower 14 supports a plurality of antennas 24 that are mounted near the apex of a column 21. As shown in FIG. 1, column 21 is monopole and is positioned near a utility support building 19.

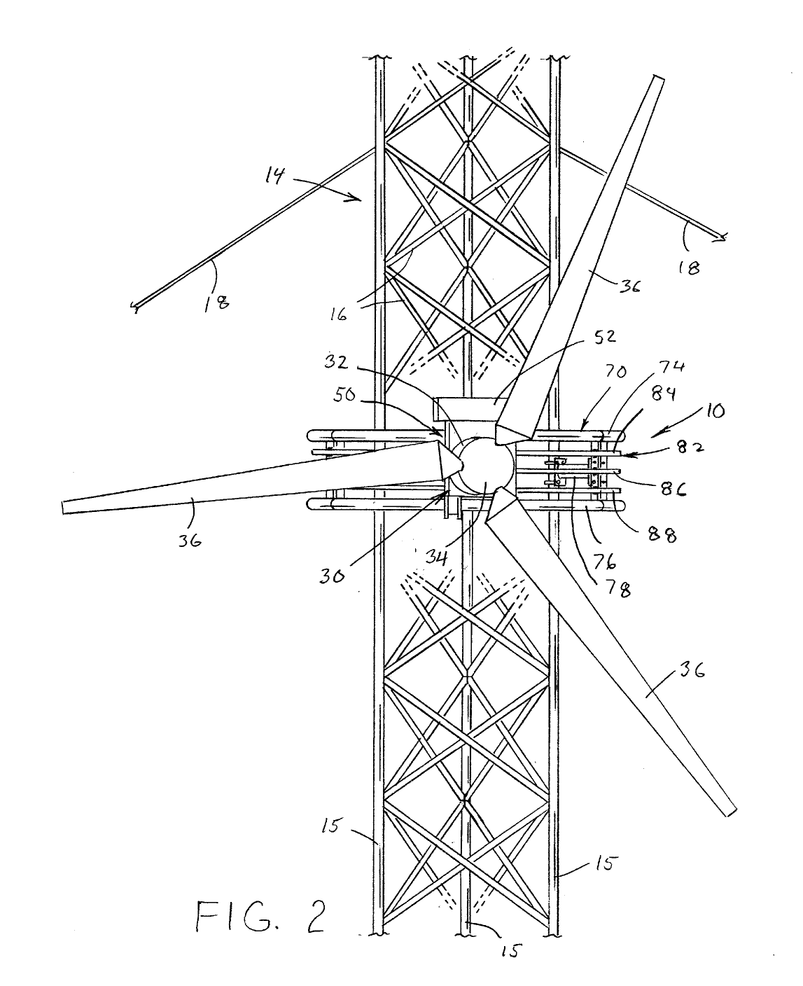

Referring now to FIG. 2, conveyance device 10 is shown positioned on a tower 14 that includes struts 16. Tower 14 is supported by legs 15 and guy wires 18 that extend from tower 14 to an anchoring structure (not shown). In the illustrated embodiment, conveyance device 10 is a yawing apparatus that is configured to orient a device for collecting energy from a natural source such as wind turbine 30. As used herein the term “yaw” refers to the horizontal position of a wind turbine or other device relative to a natural source of energy. Correspondingly, the term “yawing” refers to the act of moving the wind turbine or other device such that it is properly oriented to the natural source of energy. By way of example and not limitation, such movement can include: twisting about a vertical axis, oscillation about a vertical axis, lateral movement about a vertical axis, and a combination thereof.

Continuing to refer to FIG. 2, device 10 is configured to move wind turbine 30 in response to a change in the wind. By way of example and not limitation, such a change can be related to one of the following characteristics of the natural resource: power, direction, location, speed, and a combination thereof. Conveyance device 10 includes a carriage assembly 50 that is configured to be driven by a motor assembly 60 along a track 70. Track 70 is configured to be positioned near tower 14. Tower 14 is a pre-existing support structure or a structure on which it is desired to mount wind turbine 30 below the apex of tower 14. Wind turbine 30 is an energy collector that is configured to be attached to track 70 such that wind turbine 30 is movable relative to track 70 and tower 14 and spaced-away from tower 14 sufficient that wind turbine 30 is operational.

Referring now to FIGS. 2, 3, 4, 5, and 6; wind turbine 30 is mounted on a carriage assembly 50. Carriage assembly 50 is configured to engage track 70 and carriage assembly 50 includes a first electrical contactor 79. Electrical contactor 79 is electrically connected to the wind turbine 30 and is configured to make electrically conductive contact with a second electrical contactor, slip ring 82. Slip ring 82 is electrically connected to an electrical load 98.

Electrical load 98 can be a battery, a motor, an electrical ground, electrical storage device, and a combination thereof toward which electricity can flow from the energy collector. In a preferred embodiment, wind turbine 30 is the energy collector. In an alternative embodiment, a solar panel 130 is the energy collector. By way of example and not limitation, the solar panel can be a single collection device or an array of collection devices such as an array of solar panels or a combination of solar panels and wind turbines. It should be appreciated that other energy devices can be the energy collector.

Wind turbine 30 includes a body 32 and a hub 34. Blades 36 are attached to hub 34 and extend away from hub 34. Wind turbine 30 also includes a turbine 38 mounted within body 32. Turbine 38 is configured to generate electricity as blades 36 are driven by wind and cause hub 34 to rotate.

Wind turbine 30 is configured to be supported by a carriage assembly 50. Carriage assembly 50 includes a housing 52 that includes an interior space that is configured to receive a computer 54. An anemometer 56 is attached to housing 52 such that at least a portion of anemometer 56 extends outside of housing 52. Anemometer 56 is configured to generate a signal indicative of wind speed. A wind vane 57 configured to determine wind direction is also positioned on housing 52. Wind vane 57 is configured to generate a signal indicative of wind direction. Anemometer 56 and wind vane 57 are configured to communicate with a base controller such as a supervisory control and data acquisition controller described below.

Computer 54 can be a preprogrammed device or a programmable device configured to execute instructions such that operation of conveyance device 10 is controlled. In a preferred embodiment, computer 54 is electrically connected to a Supervisory Control and Data Acquisition (SCADA) controller. SCADA controllers are remotely installed on end users computer devices and interface with computer 54 locally by means of the WiFi Router 59 located amongst the other electronic equipment on the Carriage assembly 50. In this manner, instructions or data can be transmitted from a base controller to computer 54 and computer 54 is configured to control the operation of conveyance device 10 accordingly.

An energy storage device 97 such as a battery is positioned in housing 52 and is configured to provide electricity to computer 54 and other electrical equipment on carriage assembly 50 and associated with wind turbine 30. It should be appreciated that the electricity for recharging energy storage device 97 is provided by wind turbine 30 in the illustrated embodiment. In other embodiments, battery 97 can be replaced periodically as needed or energy storage device 97 can be recharged by power from another source.

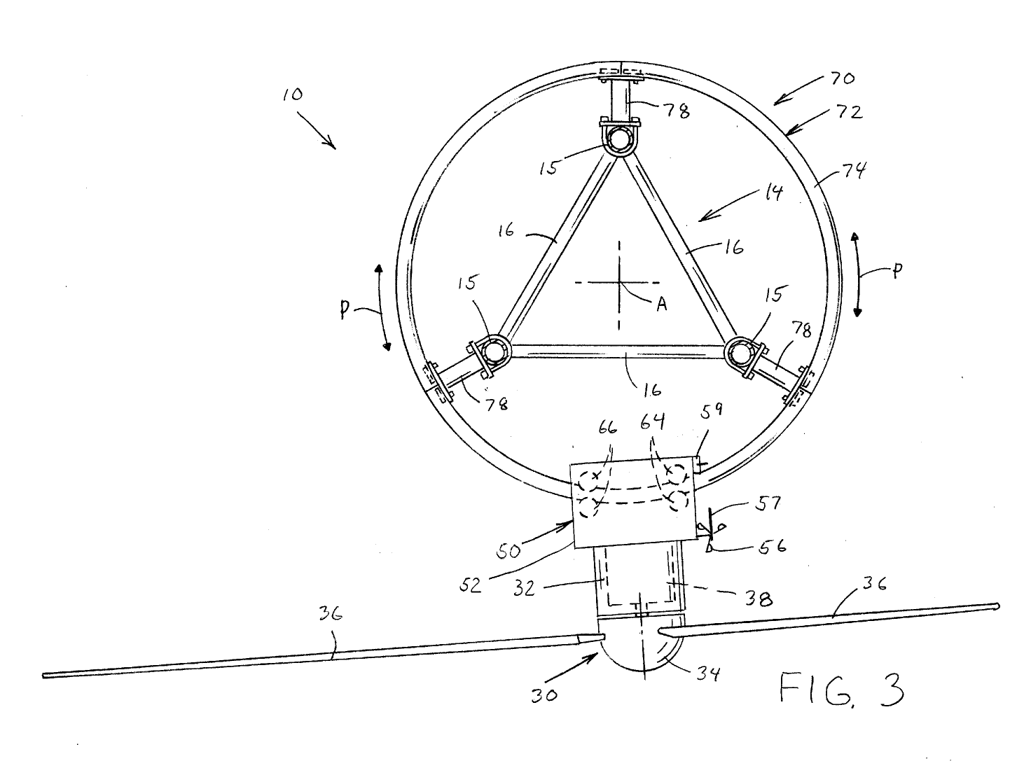

Referring now to FIG. 3, track 70 of conveyance device 10 is supported and spaced-away from tower 14 by arms 78 that are positioned horizontally in the illustrated embodiment. In other embodiments arms 78 are positioned relative to track 70 in manners other than horizontal. Track 70 is positioned such that it is concentric with the imaginary central axis A of tower 14. Axis A is a predetermined point around which wind turbine 30 is configured to travel such that it is properly oriented to the wind. In some circumstances, the positioning of obstacles near tower 14, such as a building, might require that the predetermined point around which wind turbine 30 is configured to be revolved is positioned away from axis A. In such a configuration, track 70 can be referred to as being mounted eccentrically relative to axis A.

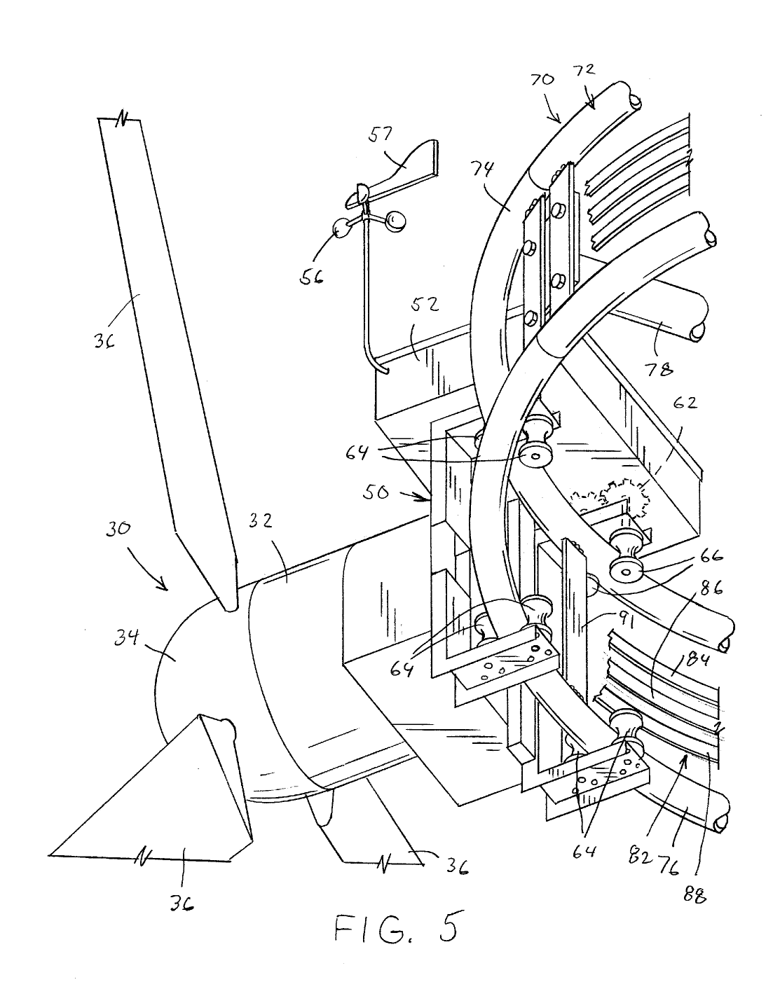

Housing 52 is also configured to receive a motor assembly 60. Motor assembly 60 includes a spur gear 62 as shown in FIG. 5 that is mechanically connected to a driven or powered rollers 66. Motor assembly 60 is configured to drive powered rollers 66 in accordance with instructions provided by computer 54 to which motor assembly 60 is electrically connected. It should be appreciated that motor assembly 60 can be configured as a stepper motor, a solenoid, or other device configured to provide mechanical power sufficient to move carriage assembly 50 along track 70.

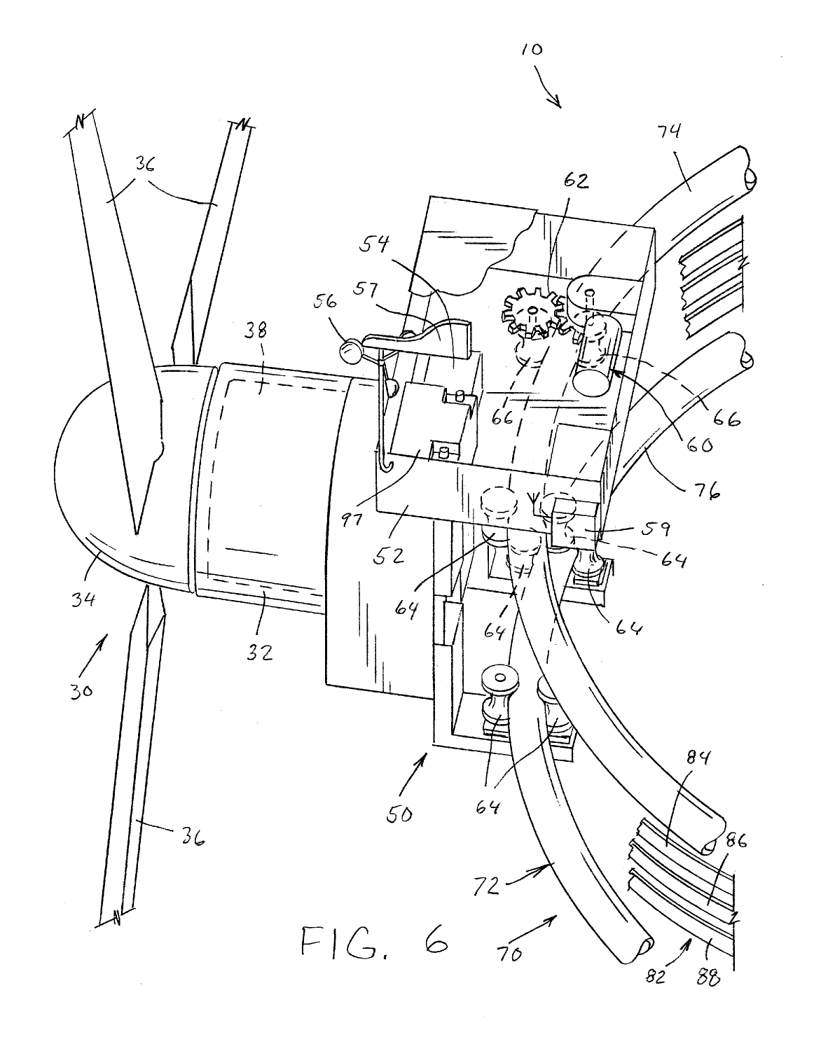

As can be seen in FIG. 6, powered rollers 66 is one of a plurality of rollers 64. Each roller 64 is configured to engage track 70. Track 70 defines a path P around tower 14 as shown in FIG. 3. In the illustrated embodiment, path P is defined by a rail assembly 72. Rail assembly 72 includes a rail ring formed by a first rail 74 and a second rail 76. It should be appreciated that, in some embodiments, powered roller 66 is a wheel, pinion, or other drive mechanism configured to drivingly engage a bearing surface defined on rail assembly 72. Likewise, rail assembly 70 can be configured such that the bearing surface is otherwise configured for improved traction. By way of example and not limitation, such alternative configurations can include additional rails, rails formed in various geometries, other surface defining structure, and a combination thereof.

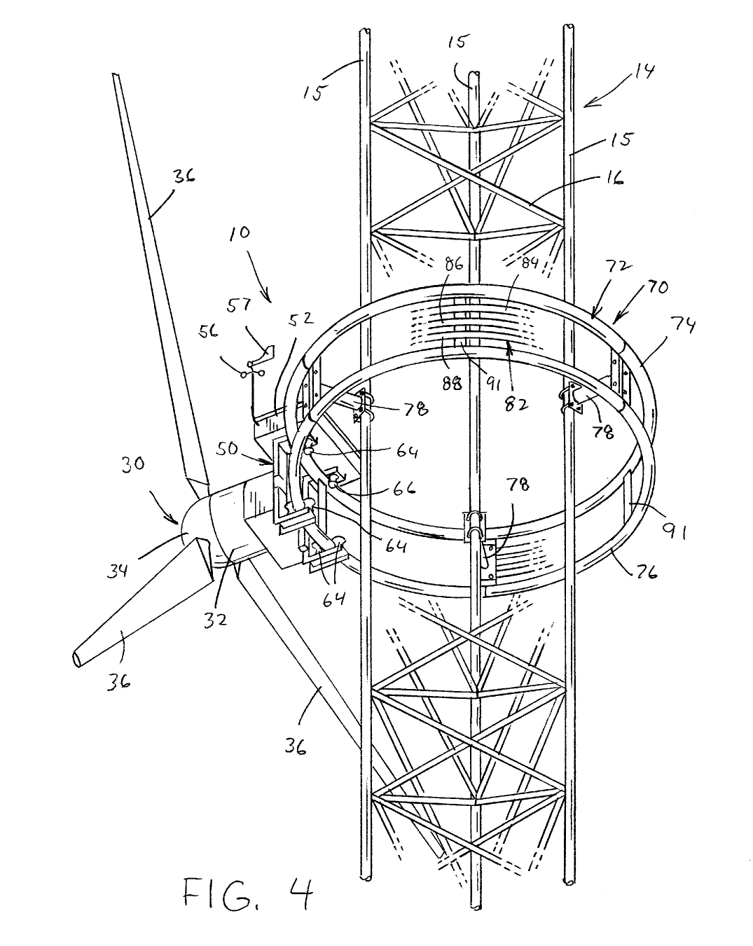

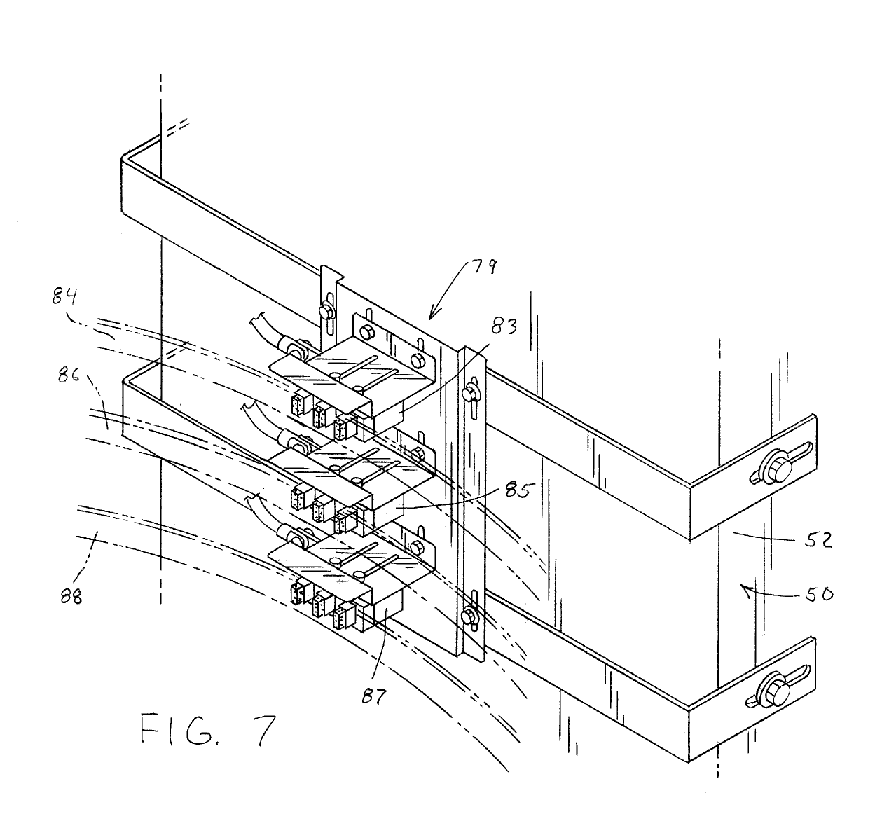

Referring now to FIGS. 4-8, slip ring 82 is configured to conduct electricity away from first contactor 79. Slip ring 82 includes a first bar 84, a second bar 86, and a third bar 88. First contactor 79 includes connectors or brushes that correspond to each bar of slip ring 82. In this regard, first contactor 79 includes a brush assembly 83 configured to electrically engage first bar 84. First contactor 79 includes a brush assembly 85 configured to electrically engage second bar 86. First contactor 79 includes a brush assembly 87 configured to electrically engage third bar 88. In the embodiment shown in FIGS. 2-6, slip ring 82 is fixedly attached to tower 14.

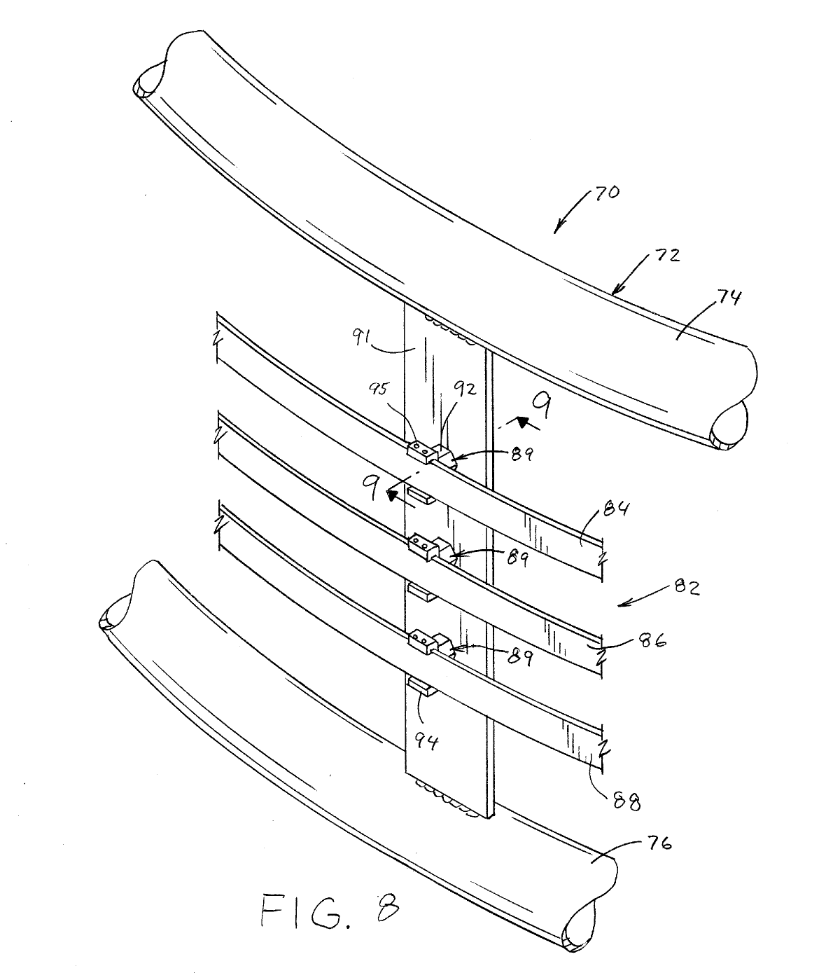

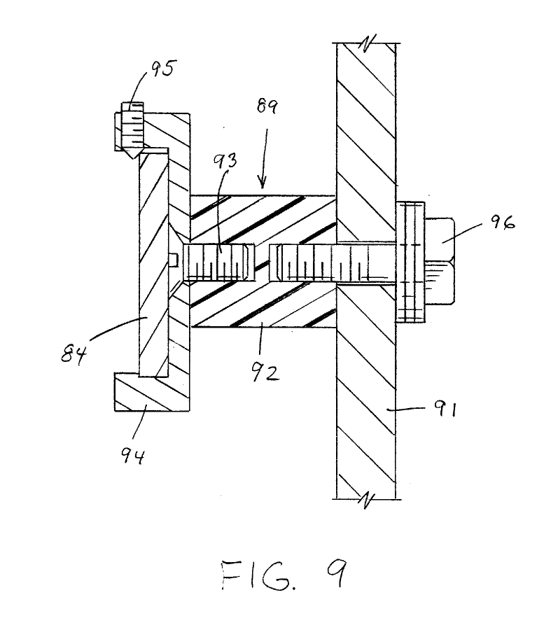

Referring now to FIGS. 8 and 9, first bar 84, second bar 86, and third bar 88 are connected together by a bar support 89. Each bar support 89 includes a bracket 91 and an insulating section 92. A channel 94 is configured within insulating section 92 to receive the associated bar section which is retained by screw 93 2 installation section 92. The associated bar section is secured within channel 94 by a set screw 95. A bolt 96 is configured to attach insulating section 92 to bracket 91.

In an alternative embodiment, the first contactor can be configured as the slip ring in the manner described above but attached to carriage assembly 50. The second contactor, which is fixed relative to track 70 would include brush assemblies in this alternative embodiment. Thus the slip ring and associated bars would move with carriage assembly 50 and the brush assemblies would be stationary relative to track 70 and tower 14.

In the embodiment shown, each brush 83, 85, and 87 is spring-loaded and configured to make electrically conductive contact with the associated bar 84,86, and 88 of slip ring 82. Slip ring 82 is electrically connected to an electrical load 98 via an electrically conductive cable or wire 99. First contactor 79 and slip ring 82 are configured such that the first contactor 79 is movable relative to slip ring 82. Additionally, first contactor 79 and slip ring 82 are configured such that wind turbine 30 and electrical load 98 are electrically connected through the first electrical contactor 79 and through the second electrical contactor slip ring 82. In some embodiments, additional brush and bar pairs are provided. Each brush and bar pair is configured to conduct a predetermined electrical current for a predetermined purpose. By way of example and not limitation, the predetermined purpose can be for: conducting power, connecting electrical components to ground, conducting data, conducting analog signals, providing an electrical common, and the like.

Conveyance device 10 can be formed of suitable materials such as, by way of example and not limitation: various metals, wood, plastic, composite materials, and a combination thereof.

The present invention can be better understood by a description of the operation thereof. In this regard, the present invention provides a method for aligning an energy collector relative to a variable source of energy by moving the energy collector relative to a predetermined point where obstructions might interfere with axial movement about the predetermined point. The method includes the steps of: positioning wind turbine 30 along track 70 at a first location on path P such that wind turbine 30 is oriented in a first direction. Device 10 is configured such that 360° is available to wind turbine 30. In this regard, wind turbine 30 can be productively directed in any direction around axis A.

The first position at which wind turbine 30 is located is generally chosen because of current wind direction that time. It should be appreciated that for maintenance or shutdown considerations, wind turbine 30 could be located at a position that is chosen based on reasons other than wind direction. In addition, in some situations when speed or turbulence might exceed rated capacity wind turbine 30. In these situations wind turbine 30 can be positioned such that it is sheltered by tower 14 from the wind or in a safe mode. The second step of moving the energy collector along path P from the first location along path P to the second location operates to orient wind turbine 32 toward a different direction without regard to the reasons for which the first location was chosen. In the third step, wind turbine 30 is operated such that electricity is generated. A fourth step includes providing the electricity that is generated to electrical load 98.

According to the illustrated embodiment, computer 54 is operational to receive signals from anemometer 56 and wind vane 57. Computer 54 is configured to activate motor assembly 60 in accordance with these signals to adjust the position of the wind turbine 30. Computer 54 is configured to initiate such actions in accordance with preprogrammed data or data input from an external source such as a human input or SCADA input. In the illustrated embodiment, communication with its human operators or external computers is achieved via Wi-Fi router 59.

According to an alternative embodiment, support structure track 70 is mounted flush to tower 14. In this embodiment, carriage assembly 50 is configured such that wind turbine 30 is sufficiently spaced away from tower 14 such that wind turbine 30 is operational. It should be appreciated that in some embodiments, track 70 can be embedded or recessed in a structure such as column 21.

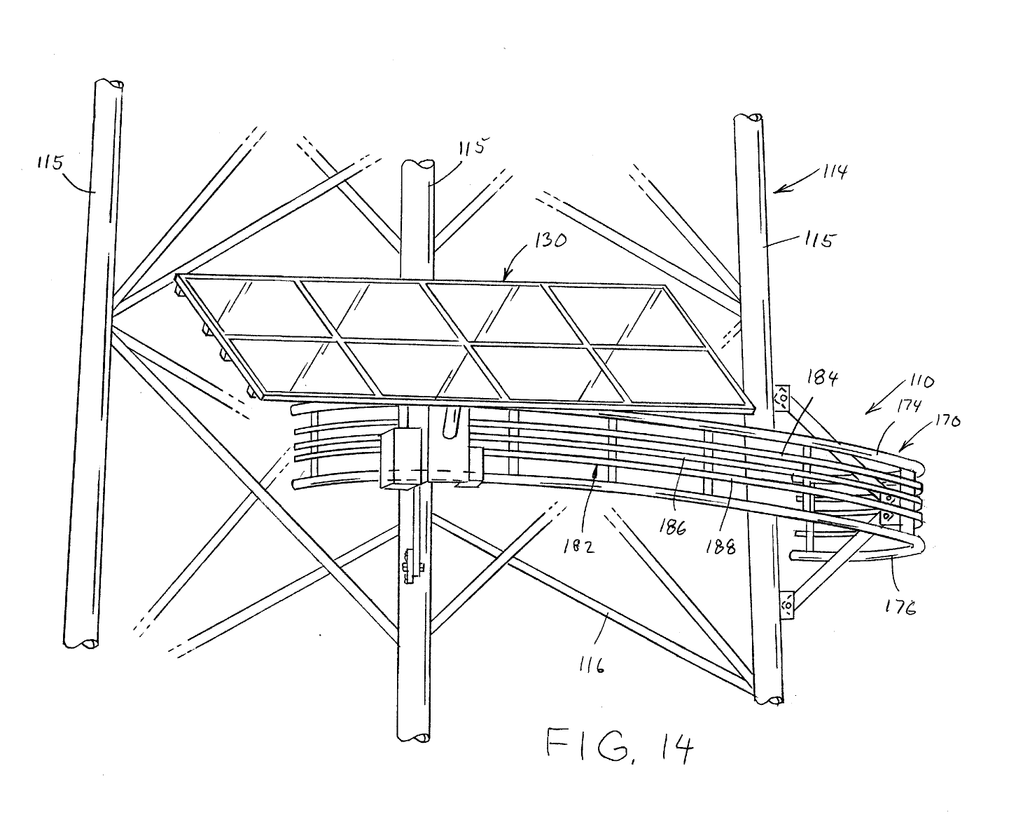

Referring now to FIG. 14, in an alternative embodiment, there is provided a conveyance device 110 that is configured to be used to align solar panels or solar collectors 130 with the changing attitude of sunlight relative to the solar collector 130 as the sun progresses along the horizon. Conveyance device 110 is generally understood by an understanding of the primary embodiment in conveyance device 10. In this regard reference numbers in the 100 series correspond to reference numbers related to device 10 refer to substantially similar elements. In this embodiment, there is provided a track 170 that extends around a tower 114 or that extends only a portion of the way around tower 114. Travel of a solar panel to the complete 360° direction available around the structure is not necessary in most installations of conveyance device 110. This is because the variation in physical location of the sun relative to the horizon is limited to a certain range depending on geographical location.

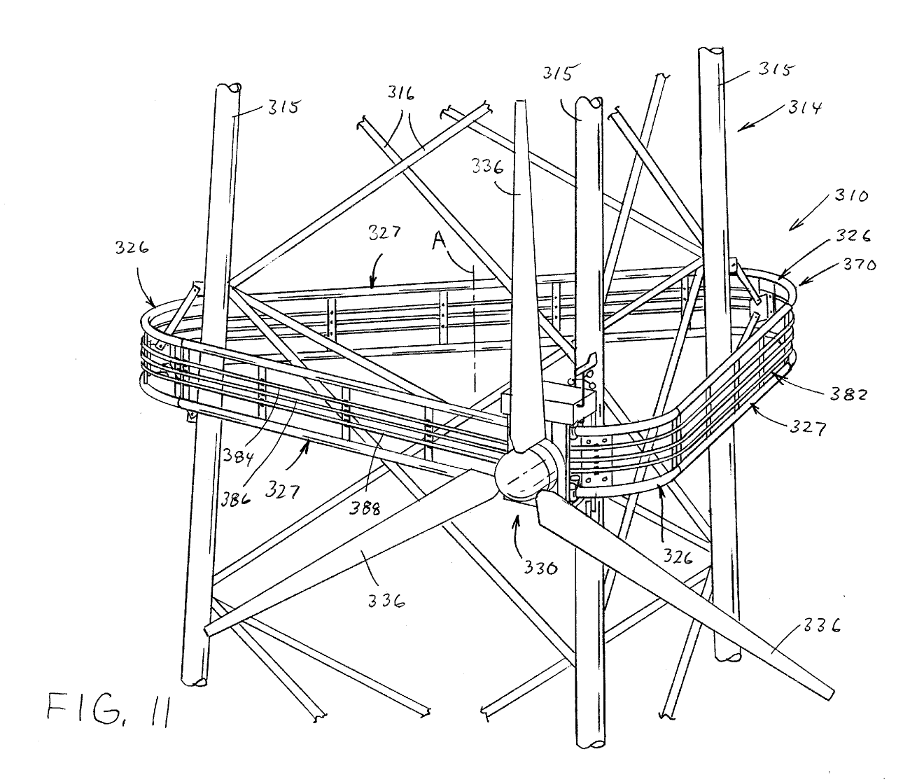

According to another alternative embodiment, shown in FIG. 11, the support structure for the carriage assembly is not a circular track 70 as shown in FIGS. 3 and 4. This embodiment provides a conveyance device 310 that can be generally understood by an understanding of device 10 of the primary embodiment through numbers of 300 series which are similar to numbers of the primary embodiment that referred to substantially similar elements.

In this alternative embodiment, the support structure is a generally triangular track 370. Track 370 includes three spaced-apart generally curved elements 326 that are connected to each other by linear elements 327. Slip ring 382 is also configured such that it is generally triangular and parallels track 370. One advantage of this embodiment is that generally curved elements 326 can be manufactured to a predetermined radius. A track 370 of suitable clearance can then be constructed using curved elements 326 spaced the predetermined distance apart from each other by one or more linear elements 327. In this manner towers and support structures of various sizes can be accommodated by the present invention with interchangeable parts. In accordance with this embodiment, all 360° available around axis A of tower 314 can be accessed by a combination of the 3 radial elements 326, each covering 120°.

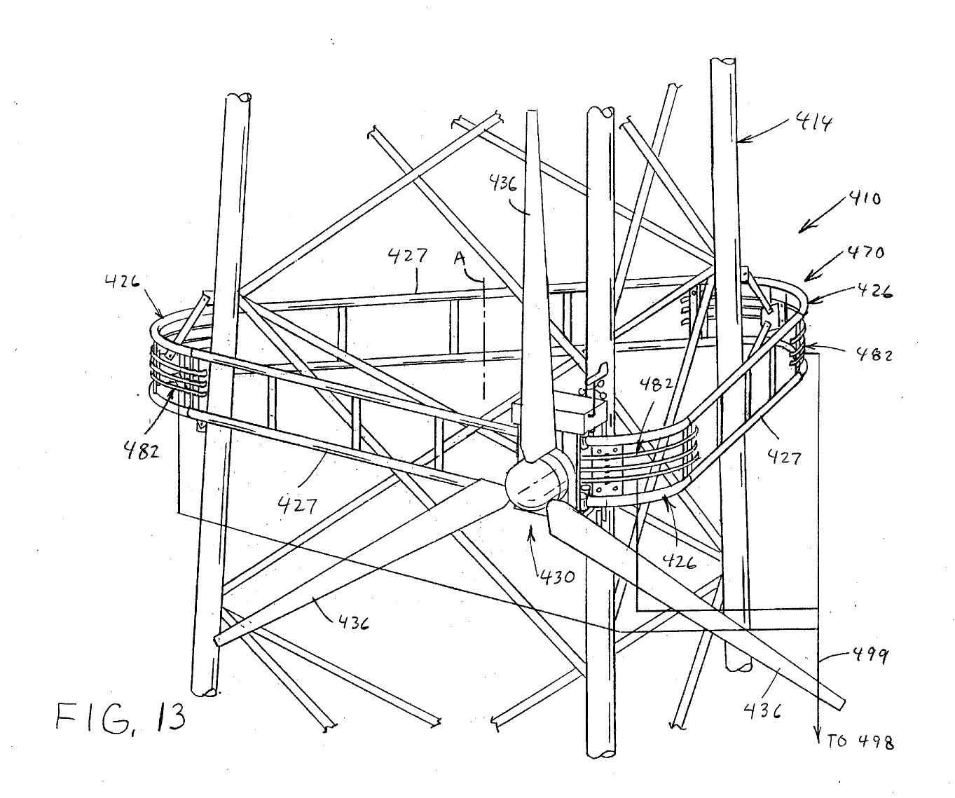

According to yet another alternative embodiment shown in FIG. 13, there is provided a conveyance device 410 that includes a generally triangular track 470 that is analogous to track 370 shown in FIG. 11. Conveyance device 410 includes a slip ring 482 defined by three spaced-apart curved elements 426. It should be appreciated that this embodiment could include sections of linear elements 427 as long as the corner elements of slip ring 482 are separated from each other as shown in FIG. 13. In this embodiment, wind turbine 430 is not electrically connected to electrical load 498 continuously as wind turbine 430 is conveyed around tower 414 by conveyance device 410. Electrical connection between wind turbine 430 and electrical load 498 is maintained when wind turbine 430 is positioned in the corners of track 470. It should be appreciated that each are in each of the three quarters track 470 include 120° such that when wind turbine 430 is conveyed through all of these radiused sections wind turbine 430 is oriented to all 360° surrounding tower 314.

It should also be appreciated that slip ring 482 and first contact 479 can be configured such that electrical contact is not made throughout the 360° revolution as possible from wind turbine 430 around tower 414, but instead is allowed in only discrete locations. For example these locations could be spaced every 10° apart. Such a configuration would not allow for most efficient orientation of wind turbine 430 relative to wind direction but might be desirable to satisfy other requirements such as those of manufacturing or installations. According to variations of this embodiment, electrical contact is made or broken by switches located along the electrical circuit between the generator of turbine 438 and the electrical load 498.

This alternative embodiment can be better understood by description of the operation thereof. In this regard there is a method provided for aligning wind turbine 430 that includes the steps of: positioning the energy collector such that it is electrically connected to the electrical load for at least some portion of a first time period during which the energy collector is at the first position; disconnecting the energy collector electrically from the electrical load such that the energy collector is not electrically connected to the electrical load for at least some portion of a second time period during which the energy collector is moving between the first position and the second position; and positioning the energy collector such that it is electrically connected to the electrical load such that they are electrically connected for at least some portion of a third time period during which the energy collector is at the second position.

The present invention provides a conveyance device for collectors of renewable energy. Sources of renewable energy, such as wind and sunlight, are by nature variable. Therefore in order to maximize energy collected from these sources and to safely operate such collectors over long periods of time, it is often required to read or in the collector such that they face different directions. Generally such movement is determined by a desire to maximize energy collection efficiency. In maximizing energy collection, the energy collector is moved such that it is exposed to the greatest available force. In other situations it is desired to shelter the energy collector from the available force. For example, when wind speed exceeds the rated capacity of a wind turbine, the wind turbine is conveyed to locations such that the wind is obstructed by the structure on which the wind turbines mounted. In this manner, the wind turbine is protected. The conveyance device of the present invention provides for positioning of an energy collector such that it is free of obstruction in the energy source caused by the tower on which it is mounted or, when necessary, advise for positioning of energy collector such that the obstruction of the tower is utilized in a positive manner

While the present invention has been illustrated and described with reference to preferred embodiments thereof, it will be apparent to those skilled in the art that modifications can be made and the Invention can be practiced in other environments without departing from the spirit and scope of the invention, set forth in the accompanying claims.

Having described the invention, the following is claimed:

1. A yawing apparatus configured to orient a device for collecting energy from a natural source by moving the device relative to the natural source to compensate for a change in the natural source, the yawing apparatus comprising:
a track configured to be positioned near a support structure;
an energy collector configured to be attached to the track such that the energy collector is movable relative to the track;
a first electrical contactor electrically connected to the energy collector;
a second electrical contactor configured to be electrically connected to an electrical load; and
wherein the first electrical contactor and the second electrical contactor are configured such that the first electrical contactor is movable relative to the second electrical contactor and are configured such that the first electrical contactor can be electrically connected to the second electrical contactor such that electricity can flow from the energy collector through the first electrical contactor and through the second electrical contactor to the electrical load.

2. A yawing apparatus according to claim 1, wherein the track is configured to support the energy collector such that the energy collector is spaced-away from the support structure.

3. A yawing apparatus according to claim 1, wherein the first and second electrical contacts are configured such that the flow of electricity from the first electrical contactor to the second electrical contactor is not interrupted when the first electrical contactor moves relative to the second electrical contactor.

4. A yawing apparatus according to claim 1, wherein the energy collector is a wind turbine.

5. A yawing apparatus according to claim 1, wherein the support structure is a telecommunications tower.

6. A yawing apparatus according to claim 1, wherein the track includes a first rail and a second rail.

7. A yawing apparatus according to claim 1, wherein the second electrical connector is stationary relative to the track.

8. A yawing apparatus according to claim 1, wherein the first electrical contactor includes electrically conductive connectors configured to electrically contact the second electrical contactor and the second electrical contactor defines a band around the support structure.

9. A yawing apparatus according to claim 1, wherein the first electric contactor electrically defines a band around the support structure that is movable relative to the track and the second electrical conductor includes electrically conductive connectors configured to electrically contact the first electrical contactor.

10. A yawing apparatus according to claim 1, wherein the energy collector includes at least one solar panel.

11. An apparatus for aligning an energy collector relative to a variable source of energy by moving the energy collector relative to a predetermined point, the apparatus comprising:
a track configured to support an energy collector such that the energy collector is spaced-away from the predetermined point;
a path P defined by the track such that the energy collector can be moved along the path P between a first location and a second location; and
wherein the track is configured such that the energy collector is oriented in a first direction when the energy collector is at the first location and the track is configured such that the energy collector is oriented in a second direction when the energy collector is at the second location.

12. An apparatus for aligning an energy collector according to claim 11, further comprising:
an energy collector that is configured to be electrically connected to an electrical load when the energy collector is at the first location and when the energy collector is at the second location.

13. An apparatus for aligning an energy collector according to claim 11, wherein the energy collector is configured such that it can be electrically disconnected from an electrical load when the energy collector is between the first location and the second location.

14. An apparatus for aligning an energy collector according to claim 11, wherein the energy collector is a wind turbine.

15. An apparatus for aligning an energy collector according to claim 11, wherein the support structure is a telecommunications tower.

16. An apparatus for aligning an energy collector according to claim 11, wherein the first electrical contactor includes electrically conductive connectors configured to electrically contact the second electrical contactor and the second electrical contactor defines a band around the support structure.

17. An apparatus for aligning an energy collector according to claim 11, wherein the first electric contactor electrically defines a band around the support structure and the second electrical conductor includes electrically conductive connectors that are configured to electrically contact the first electrical contactor.

18. An apparatus for aligning an energy collector according to claim 11, wherein the energy collector includes a solar panel.

19. A method for aligning an energy collector relative to a variable source of energy by moving the energy collector relative to a predetermined point where obstructions might interfere with axial movement about the predetermined point, the method comprising the steps of:
providing an energy collector, a track configured to support the energy collector such that the energy collector is spaced-away from the predetermined point, a path P defined by the track such that the energy collector can be moved along the path P between a first location and a second location, and wherein the energy collector is configured to be oriented in a first direction when the energy collector is at the first location and the energy collector is configured to be oriented in a second direction when the energy collector is at the second location;
positioning the energy collector at the first location on path P such that the energy collector is oriented in the first direction;
moving the energy collector along path P between the first location on path P and the second location on path P;
positioning the energy collector at the second location on path P such that the energy collector is oriented in the second direction;
operating the energy collector such that electricity is generated; and
providing the electricity that is generated to a electrical load.

20. A method for aligning an energy collector according to claim 19, the method further comprising the steps of:
positioning the energy collector such that it is electrically connected to the electrical load for at least some portion of a first time period during which the energy collector is at the first position;
disconnecting the energy collector electrically from the electrical load such that the energy collector is not electrically connected to the electrical load for at least some portion of a second time period during which the energy collector is moving between the first position and the second position; and
positioning the energy collector such that it is electrically connected to the electrical load such that they are electrically connected for at least some portion of a third time period during which the energy collector is at the second position.
